(19) United States
(12) Patent Application Publication
(10) Pub. No.: US 2011/0302769 A1
(43) Pub. Date: Dec. 15, 2011

(54) METHOD OF MANUFACTURING STATOR

(75) Inventors: Masaki SAITO, Okazaki-shi (JP); Shinya SHIMIZU, Okazaki-shi (JP); Susumu KATO, Anjo-shi (JP)

(73) Assignee: AISIN AW CO., LTD., Anjo-shi (JP)

(21) Appl. No.: 13/156,754

(22) Filed: Jun. 9, 2011

(30) Foreign Application Priority Data
Jun. 15, 2010 (JP) 2010-136034

(51) Int. Cl. H02K 15/02

(52) U.S. Cl. 29/596

(57) ABSTRACT

A method of manufacturing a stator includes forming a stator by assembling segment cores, formed by dividing a stator core in a circumferential direction at a formation position of a slot of the stator core, to a coil conductor that is formed of a rectangular wire bent to include linear portions arranged in the slot and bridge portions that alternately connect the linear portions on one end and the other end of the coil conductor such that the linear portions can be arranged side by side on an imaginary circumference, and fitting a heated outer peripheral ring to an outer periphery of the segment cores. The method also includes reheating the stator at a predetermined temperature in a state where a circularity of the stator is corrected by restraining the outer peripheral ring in the stator to improve the circularity of the stator.

### INCORPORATION BY REFERENCE

The disclosure of Japanese Patent Application No. 2010-136034 filed on Jun. 15, 2010 including the specification, drawings and abstract is incorporated herein by reference in its entirety.

### BACKGROUND OF THE INVENTION

The present invention relates to a method of manufacturing a stator in which a coil conductor is arranged in slots of a stator core.

### DESCRIPTION OF THE RELATED ART

To manufacture a stator for a rotary electric machine that is used in a hybrid vehicle, an electric vehicle, or the like, a coil conductor is formed of a rectangular wire whose cross-section is generally rectangular-shaped in order to increase the area of the slot of a stator core occupied by the coil conductor. In this case, the coil conductor formed of the rectangular wire cannot be inserted into the slots in the annular stator core. A plurality of segment cores is thus formed by dividing the stator core at a formation position of every other slot.

The plurality of segment cores is then assembled to the coil conductor that is formed into a shape to be arranged in the slots. Further, for example, an outer peripheral ring is shrink-fit to an outer periphery of the plurality of segment cores (the outer peripheral ring is heated and expanded to be fit to the segment cores).

For example, in a method of manufacturing a rotary electric machine described in Japanese Patent Application Publication No. JP-A-2009-106137, a tightening member is attached to an outer periphery of a segment stator core, and presses each segment stator core radially inward so as to displace each segment stator core in order to secure an inner diameter circularity of a stator.

In addition, for example, Japanese Patent Application Publication No. JP-A-2001-218429 describes that, in an electric motor, a stator is manufactured by assembling a stator core in which a yoke portion is divided into a plurality of parts in a circumferential direction, and installing a metal mold on teeth tip end portions of the stator core so as to radially apply stress to the stator core in a uniform state in a circumferential direction.

### SUMMARY OF THE INVENTION

However, it has been found that, when the coil conductor formed of the rectangular wire is assembled in a plurality of slots in the stator core in a bridged and distributed winding manner, the circularity of the stator is reduced after the outer peripheral ring is attached to the plurality of segment cores by shrink fitting. This reduction in the circularity is due to the following. That is, a dimensional error may occur between the slots and the coil conductor due to, for example, a variation in dimensional accuracy that occurs when the rectangular wire is processed by bending. This results in considerable deformation of the coil conductor arranged in the slots. Therefore, when all the segment cores are assembled to the coil conductor, a force that causes the deformed coil conductor to regain its original shape presses the plurality of segment cores toward an outer peripheral side, resulting in a reduction in circularity of the stator.

It should be noted that, in Patent Documents 1 and 2, there are no devices described for suppressing a reduction in the circularity after the above shrink-fitting.

The present invention has been devised in consideration of the foregoing problem with related art, and it is an object of the present invention to provide a method of manufacturing a stator that is capable of effectively suppressing a reduction in the circularity of the stator after a heated outer peripheral ring is fit to an outer periphery of a plurality of segment cores.

A first aspect of the present invention provides a method of manufacturing a stator, the method being characterized by including: a stator formation process of forming a stator by assembling a plurality of segment cores, which is formed by dividing a stator core in a circumferential direction at a formation position of a slot of the stator core, to a coil conductor that is formed of a rectangular wire bent to include linear portions arranged in the slot and bridge portions that alternately connects the linear portions on one end and the other end of the coil conductor such that the linear portions can be arranged side by side on an imaginary circumference, and fitting a heated outer peripheral ring to an outer periphery of the plurality of segment cores; and a correction process of reheating the stator at a predetermined temperature in a state where a circularity of the stator is corrected by restraining the outer peripheral ring in the stator so as to improve the circularity of the stator.

The stator manufactured according to the first aspect of the present invention is formed by assembling the coil conductor formed of the rectangular wire to the plurality of slots in the stator core in a bridged and distributed winding manner.

In the method of manufacturing a stator according to the first aspect of the present invention, the stator is formed in the stator formation process in which the plurality of segment cores is assembled to the coil conductor formed by bending the rectangular wire, and the heated outer peripheral ring is fit to the outer periphery of the plurality of segment cores. Then, in the correction process, the stator is reheated at the predetermined temperature in the state where the circularity of the stator is corrected by restraining the outer peripheral ring in the stator.

This reheating makes it possible to reduce a force that causes the coil conductor deformed when arranged in the slots to regain its original shape. Consequently, it is possible to suppress the force that causes the deformed coil conductor to regain its original shape from serving as a residual stress that presses and expands the segment cores.

Therefore, according to the method of manufacturing a stator of the first aspect of the present invention, it is possible to effectively suppress a reduction in the circularity of the stator after the heated outer peripheral ring is fit to the outer periphery of the plurality of segment cores.

### BRIEF DESCRIPTION OF THE DRAWINGS

FIG. 1 is a sectional explanatory diagram showing a state where a correction jig is attached to a stator according to an embodiment, as viewed from an axial direction of the stator;

FIG. 2 is a sectional explanatory diagram showing the state where the correction jig is attached to the stator according to the embodiment, as viewed from a side of the stator;

FIG. 3 is a perspective view showing an overall configuration of a coil conductor according to the embodiment;

FIG. 4 is a sectional explanatory diagram showing a state where segment cores are assembled to the coil conductor as viewed from the axial direction of the stator according to the embodiment;

FIG. 5 is a sectional explanatory diagram showing a state before an outer peripheral ring is shrink-fit to a segment core assembly according to the embodiment;

FIG. 6 is a sectional explanatory diagram showing a state where the outer peripheral ring is shrink-fit to the segment core assembly according to the embodiment;

FIG. 7 is a sectional explanatory diagram showing the stator according to the embodiment, as viewed from the axial direction;

FIG. 8 is a sectional explanatory diagram showing the stator according to the embodiment, as viewed from a side of the stator;

FIG. 9 is a sectional explanatory diagram schematically showing a state where the coil conductor is arranged in the stator according to the embodiment, as viewed from the axial direction of the stator;

FIG. 10 is an explanatory diagram showing the correction jig as viewed from the axial direction of the stator according to the embodiment;

FIG. 11 is an explanatory diagram showing a state where varnish is dripped to the stator for varnish impregnation according to the embodiment;

FIG. 12 is a sectional explanatory diagram showing a state where the correction jig is attached to the stator according to the embodiment, as viewed from the axial direction of the stator when measurement is performed by a measuring device;

FIG. 13 is a sectional explanatory diagram showing a state where the correction jig is attached to the stator according to the embodiment, as viewed from a side of the stator when measurement is performed by the measuring device;

FIG. 14 is an explanatory diagram showing a state where the correction jig is attached to the stator when heating is performed using a hot air fan according to the embodiment;

FIG. 15 is an explanatory diagram showing a state where the correction jig is attached to the stator when heating is performed using an induction heating coil according to the embodiment;

FIG. 16 is a graph showing a measurement result in a confirmation test of a radius of inner peripheral surfaces on teeth portions of each segment core before performing a correction process;

FIG. 17 is a graph showing a measurement result in the confirmation test of the radius of the inner peripheral surfaces on the teeth portions of each segment core after correction by jig;

FIG. 18 is a graph showing a measurement result in the confirmation test of the radius of the inner peripheral surfaces on the teeth portions of each segment core after heating; and

FIG. 19 is a graph showing a measurement result in the confirmation test of the radius of the inner peripheral surfaces on the teeth portions of each segment core after jig detachment.

### DETAILED DESCRIPTION OF THE EMBODIMENT

An embodiment of a method of manufacturing a stator according to the present invention above will be described.

In a correction process according to the present invention, a predetermined temperature at which the stator is reheated may be set to equal to or lower than a heat-resistant temperature of an insulation layer that covers a rectangular wire forming a coil conductor. This predetermined temperature at which the stator is reheated may be set such that, for example, the temperature of the coil conductor becomes 100° C. to 200° C.

Further, in the correction process, a correction jig arranged on an outer peripheral side of an outer peripheral ring may be used to partially press the outer peripheral ring in the circumferential direction. The correction jig may include a body portion arranged on the outer peripheral side of the outer peripheral ring, and an adjustment portion whose radial position is adjusted with respect to the body portion and that presses a corresponding segment core from the outer peripheral side. In this case, it is possible to easily correct the circularity of the stator by attaching the correction jig to the stator to which the outer peripheral ring is shrink-fit and adjusting the adjustment portion.

Further, the body portion may be formed of an annular ring member, and the ring member may be formed with screw holes at positions facing an outer peripheral side of the plurality of segment cores. The adjustment portion may be an adjustment bolt that is screwed into each of the screw holes, and a tip end of the adjustment bolt may press the outer periphery of the corresponding segment core so as to improve the circularity of the stator.

In this case, it is possible to easily adjust a force that presses each of the segment cores by tightening the adjustment bolt, whereby the circularity of the stator is further improved.

Further, the correction process may be performed in a varnish impregnation process of impregnating varnish in a gap between the coil conductor and the slots, and the predetermined temperature at which the stator is reheated may be a heating temperature to harden the varnish.

In this case, it possible to reheat the stator utilizing the heating temperature when impregnating the varnish, whereby the time required for the correction process can be reduced and the equipment can be simplified.

Further, in the correction process, a radius from a center of the stator to teeth inner peripheral surfaces of each of the plurality of segment cores may be measured using a measuring device, and the segment core with the measured radius larger than that of the other segment cores may be pressed toward an inner peripheral side so as to improve the circularity of the stator.

In this case, it is possible to directly press toward the inner peripheral side the segment cores that should be corrected to ensure the circularity, whereby the circularity of the stator can be further improved.

### Embodiment

An embodiment of a method of manufacturing a stator according to the present invention will be hereinafter described with reference to the drawings.

In a method of manufacturing a stator 1 according to the present embodiment, the stator 1 for a rotary electric machine is manufactured by performing a stator formation process and a correction process to be described next.

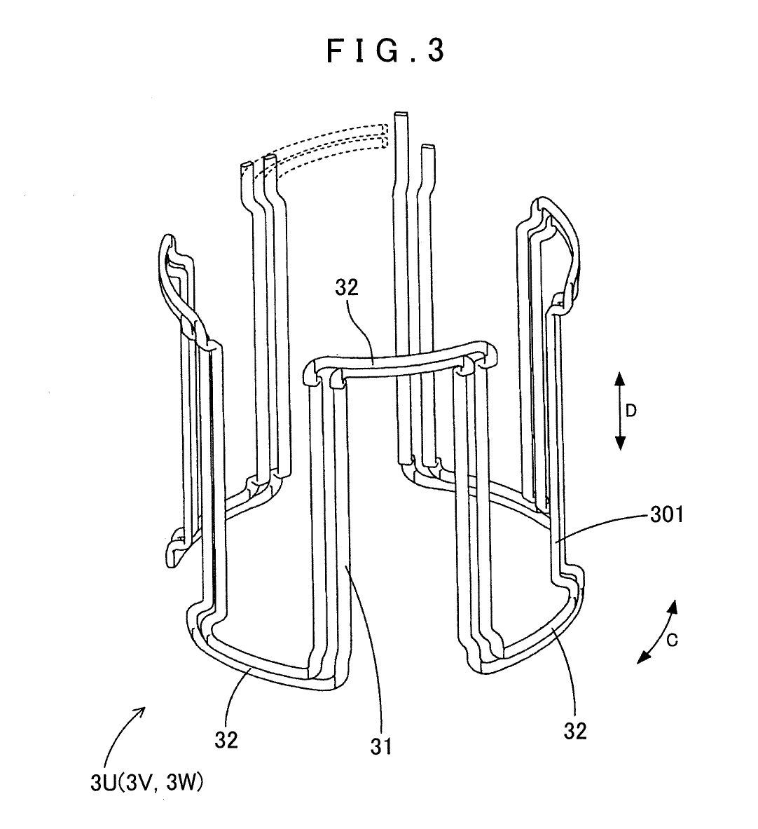

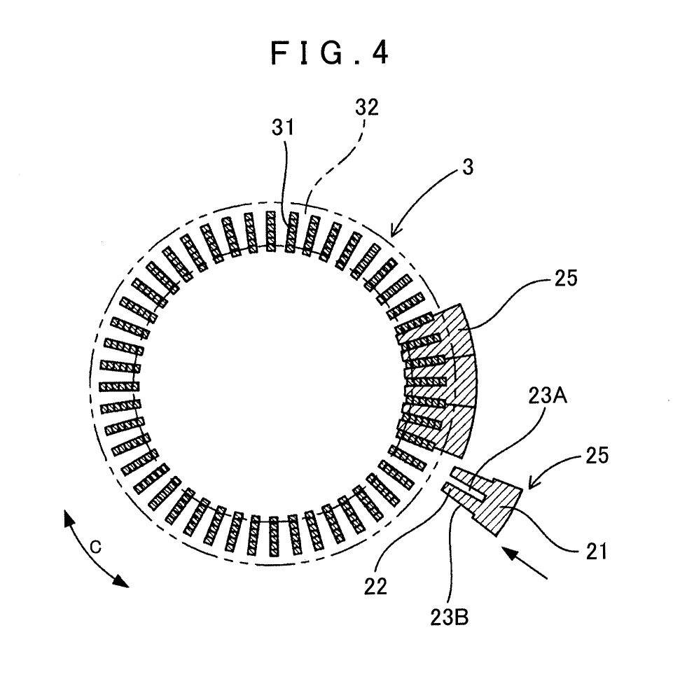

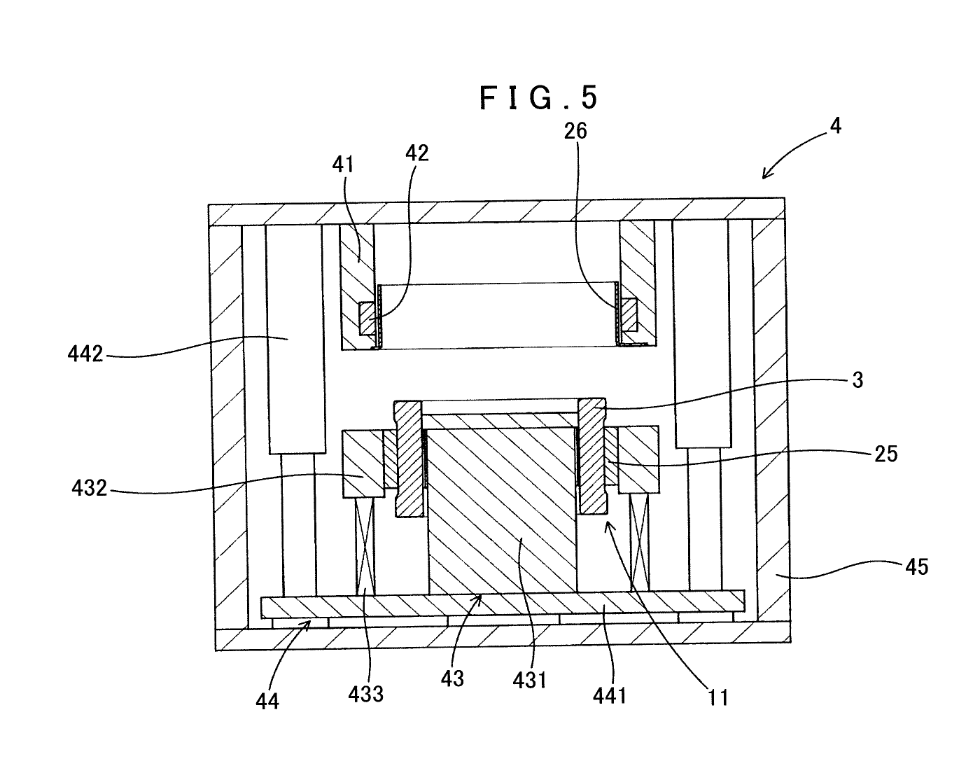

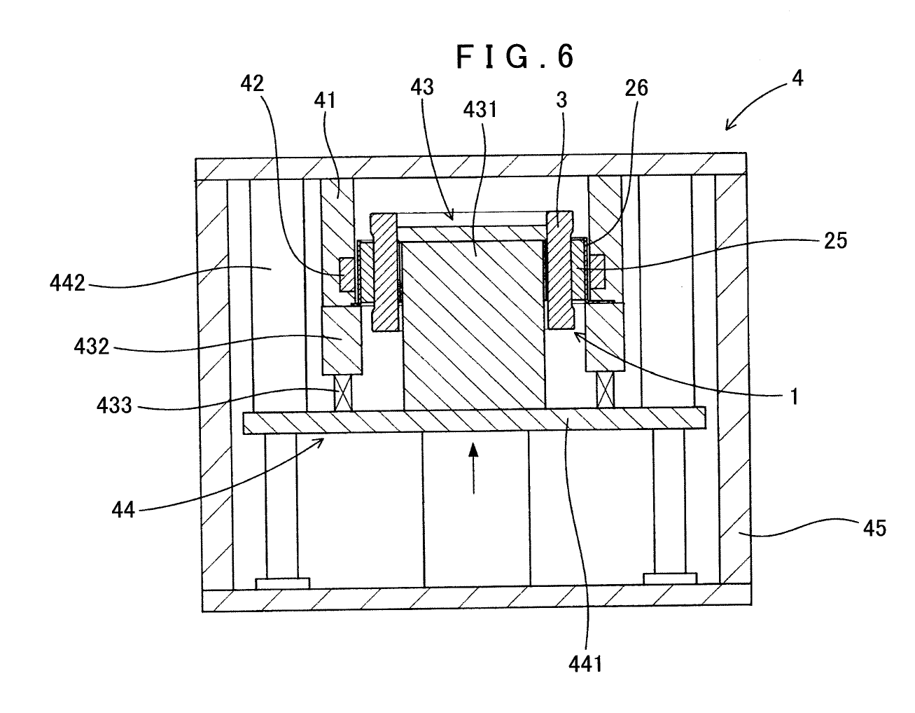

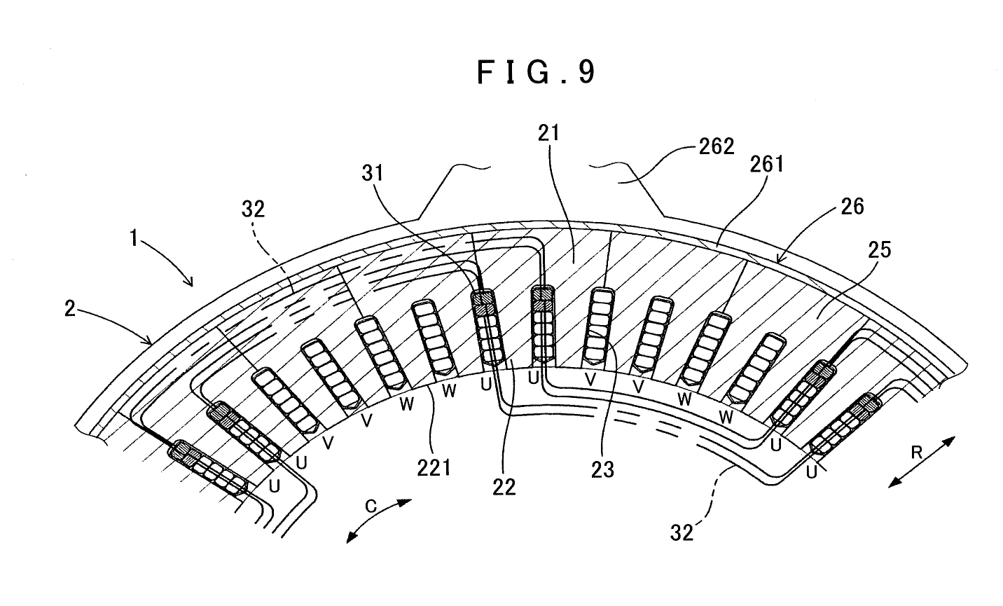

In the stator formation process, as shown in FIGS. 3 and 9, a rectangular wire 301 whose cross-section is generally rectangular-shaped is processed by bending so as to form a coil conductor 3. The coil conductor 3 includes linear portions 31 to be respectively arranged in a plurality of slots 23 of a stator core 2, and bridge portions 32 that alternately connect the linear portions 31 on one end and the other end of the coil conductor 3 so as to arrange the linear portions 31 side by side on an imaginary circumference. Next, as shown in FIG. 4, a plurality of segment cores 25 is formed by dividing the stator core 2 in a circumferential direction C at a formation position of every other slot 23, and assembled to the coil conductor 3. As shown in FIGS. 5 and 6, a heated outer peripheral ring 26 is then fit to an outer periphery of the plurality of segment cores 25 so as to form the stator 1.

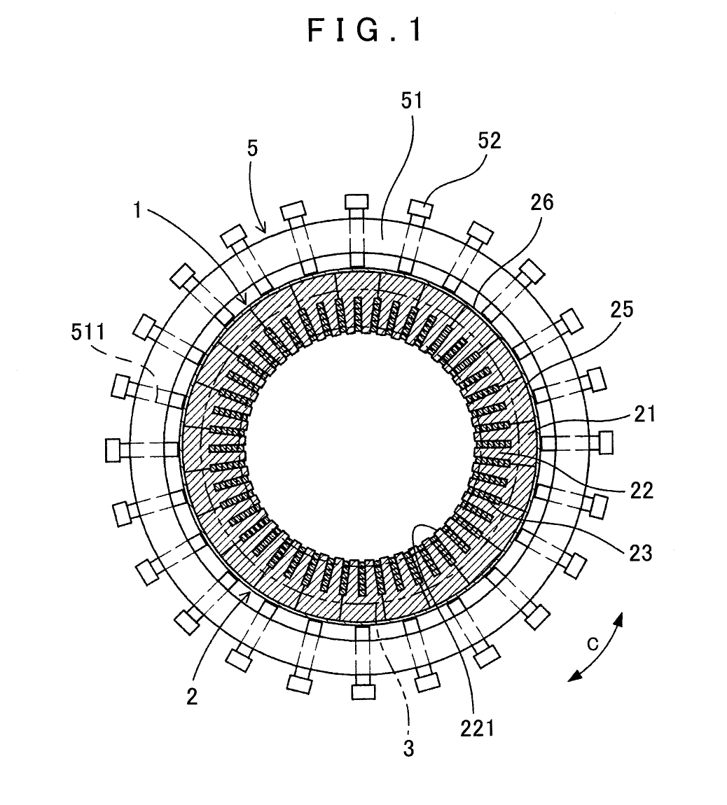

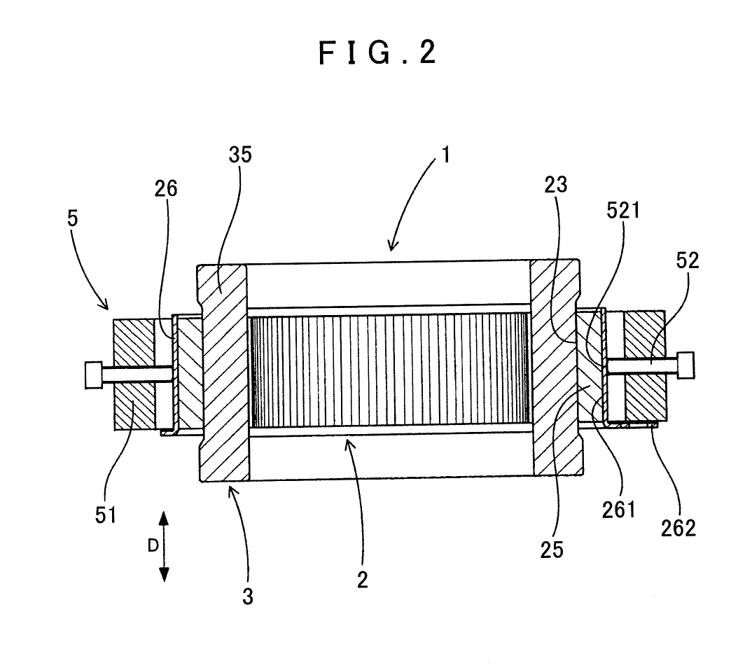

In the correction process, as shown in FIGS. 1 and 2, a circularity of the stator 1 is corrected by restraining the outer peripheral ring 26 in the stator 1. Then, the stator 1 is reheated at a predetermined temperature in this corrected state so as to improve the circularity of the stator 1.

The method of manufacturing the stator 1 according to the present embodiment will be hereinafter described in detail with reference to FIGS. 1 to 15.

The stator 1 of the present embodiment is used for a three-phase rotary electric machine, and the three-phase rotary electric machine is configured such that an inner rotor is rotatably arranged on an inner peripheral side of the stator 1.

As shown in FIG. 9, a U-phase coil conductor 3U, a V-phase coil conductor 3V, and a W-phase coil conductor 3W are arranged in the plurality of slots 23 in the stator core 2 in a distributed winding manner. Each of the U-phase coil conductor 3U, the V-phase coil conductor 3V, and the W-phase coil conductor 3W is formed into a wave-winding shape in which the plurality of linear portions 31 is alternately connected by the bridge portions 32 on the one end and the other end of the coil conductors 3. Further, the stator core 2 is provided with the coil conductor 3 of each phase that is formed to include a plurality of turns and encircles the stator 1 in the circumferential direction C. In each of the slots 23 in the stator core 2, the linear portions 31 of the coil conductor 3 of any one of the U phase, the V phase, and the W phase are arranged such that the linear portions 31 overlap each other in a radial direction R.

As shown in FIG. 3, in the stator formation process of the present embodiment, the rectangular wire 301 whose cross-section is generally rectangular-shaped is processed by bending into a wave-winding shape in which the linear portions 31 are connected by the bridge portions 32, and the bent rectangular wire 301 is rolled into a cylindrical shape to serve as the coil conductors 3U, 3V, 3W of the respective phases.

As shown in FIG. 4, each of the segment cores 25 constituting the stator core 2 is formed with one center slot 23A, and a pair of divided slots 23B formed by dividing the slots 23 on both sides of the center slot 23A. The segment cores 25 are formed by dividing a yoke portion 21 on an outer peripheral side of every other slot 23, and each include two teeth portions 22 positioned between each pair of the slots 23.

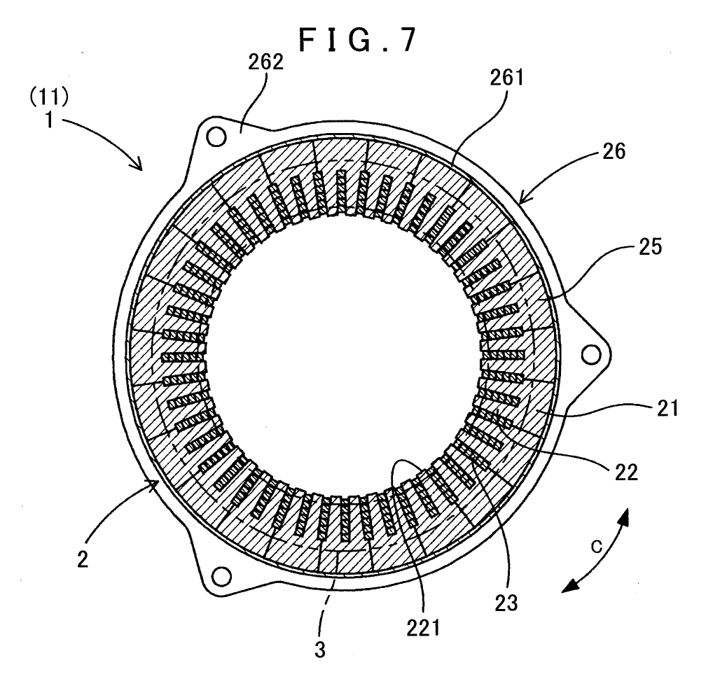

As shown in FIG. 7, the stator core 2 is formed by fitting the outer peripheral ring 26 to the plurality of segment cores 25. The stator core 2 includes an even number of the slots 23 (48 in the present embodiment) and the number of the segment cores 25 is half the number of slots 23 (24 in the present embodiment). The slots 23 are each formed as a parallel slot in which a pair of lateral wall surfaces in the circumferential direction C are parallel to each other.

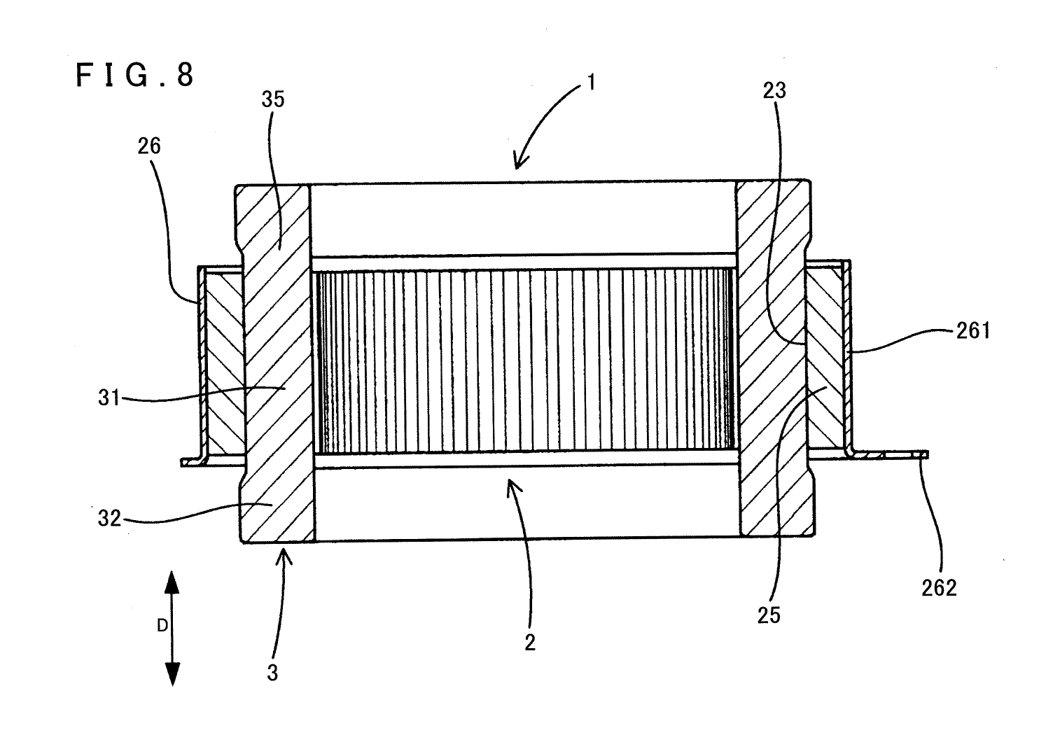

As shown in FIGS. 7 and 8, the outer peripheral ring 26 includes a cylindrical body portion 261 and attachment portions 262 formed to extend from three locations of the cylindrical body portion 261 in the circumferential direction C. An inner diameter of the outer peripheral ring 26 is generally equal to or slightly smaller than an outer diameter of an outer peripheral surface of the assembled plurality of segment cores 25.

In the coil conductor 3 arranged in the stator core 2, most of the linear portions 31 are arranged in the respective slots 23, and the remaining linear portions 31 and the bridge portions 32 are arranged on an outer side of an axial end surface of the stator core 2. The remaining linear portions 31 and the bridge portions 32 together form coil end portions 35 of the stator 1.

In the stator formation process of the present embodiment, after forming a segment core assembly 11 by assembling all the segment cores 25 to all the coil conductors 3 of the three phases, a shrink fit device 4 is used to shrink-fit the outer peripheral ring 26 to the segment core assembly 11 as shown in FIG. 5. The shrink fit device 4 includes a ring holding portion 41 that holds the outer peripheral ring 26, a heater 42 that heats the outer peripheral ring 26 in the ring holding portion 41, a core holding portion 43 that holds the segment core assembly 11, and a moving unit 44 that moves the core holding portion 43 relative to the ring holding portion 41.

The core holding portion 43 includes an inner peripheral side holding portion 431 that holds an inner peripheral side of the segment core assembly 11 on an inner peripheral side and an outer peripheral side holding portion 432 that holds an outer peripheral side of the segment core assembly 11. The ring holding portion 41 of the present embodiment is fixed to a base 45. The moving unit 44 is configured to move the core holding portion 43, and includes a movement base 441 that fixes the inner peripheral side holding portion 431 and fixes the outer peripheral side holding portion 432 via a cushion 433, and posts 442 that guide the movement of the movement base 441. The movement base 441 is configured to move by a power source (not shown) or a manually operated drive source.

As shown in FIG. 6, the outer peripheral ring 26 is heated by the heater 42, and the moving unit 44 moves the segment core assembly 11 held in the core holding portion 43 with respect to the outer peripheral ring 26 held in the ring holding portion 41. This fits the heated outer peripheral ring 26 with an expanded inner diameter to the segment core assembly 11. The outer peripheral ring 26 is then cooled and the inner diameter thereof shrinks back, which consequently integrates the plurality of segment cores 25 and the outer peripheral ring 26 and thus forms the stator 1.

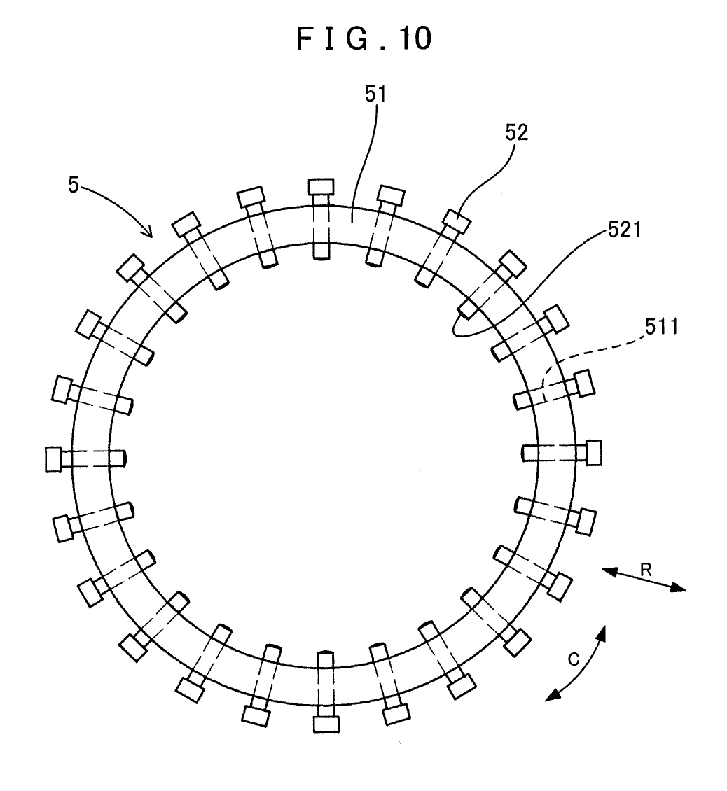

In the correction process of the present embodiment, as shown in FIG. 10, a correction jig 5 arranged on an outer peripheral side of the outer peripheral ring 26 is used to partially press the outer peripheral ring 26 in the circumferential direction C. The correction jig 5 includes a body portion 51 formed of an annular ring member arranged on the outer peripheral side of the outer peripheral ring 26, and adjustment portions 52 whose positions are adjusted in the radial direction R with respect to the body portion 51 and that press the corresponding segment core 25 from the outer peripheral side. Screw holes 511 are formed in the body portion 51 at positions respectively facing an outer peripheral side of the plurality of segment cores 25. The adjustment portion 52 of the present embodiment is an adjustment bolt 52 screwed into each of the screw holes 511.

As shown in FIGS. 1 and 2, the correction jig 5 tightens each of the adjustment bolts 52 in the body portion 51, and a tip end 521 of the adjustment bolt 52 presses the outer periphery of the corresponding segment core 25 so as to improve the circularity of the stator 1. More specifically, the correction jig 5 is attached to the stator 1 to which the outer peripheral ring 26 is shrink-fit so as to adjust the adjustment bolts 52. Then, the adjustment bolts 52 directly press the respective segment cores 25 toward the inner peripheral side, and this applies to the segment cores 25 a force that causes the wave-winding-shaped coil conductor 3 that has been deformed to regain its original shape. Consequently, pressing of the segment cores 25 toward the outer peripheral side can be reduced. This makes it possible to easily correct the circularity of the stator 1.

Further, the correction process is performed in a varnish impregnation process in which gaps between the coil conductor 3 and the slots 23 are impregnated with varnish.

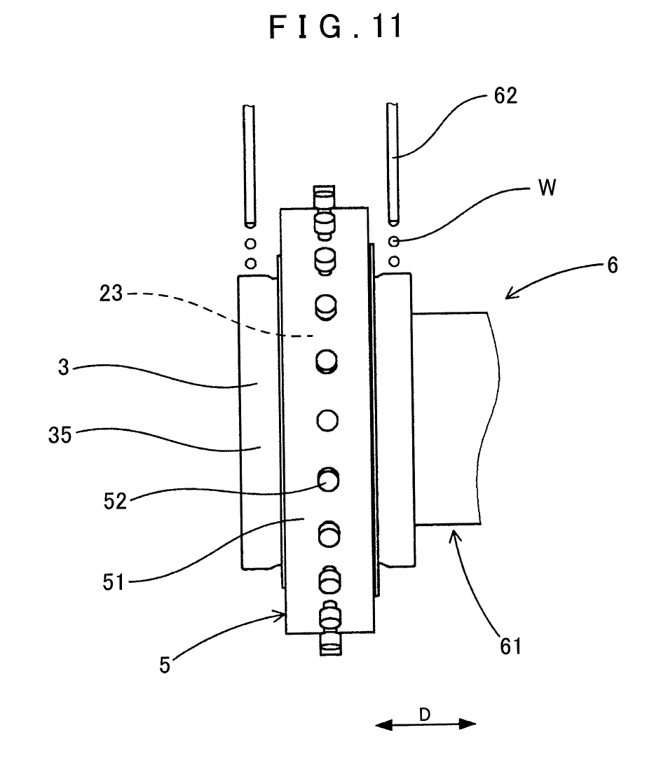

In the varnish impregnation process, as shown in FIG. 11, a varnish impregnation device 6 is used to drip varnish W, which is made of an insulative resin material, onto the coil end portions 35 of the stator 1, and the dripped varnish W is impregnated into the slots 23 by surface tension produced on the coil conductor 3. The varnish impregnation device 6 includes a rotary device 61 that holds the stator 1 with an axial direction D of the stator 1 oriented to a horizontal direction, nozzles 62 that drip the varnish W, and a vacuum chamber (not shown) that places the environment under which the varnish W is dripped in a vacuum state.

In the present embodiment, after the stator formation process described above is performed, the correction process is performed at the same time as the varnish impregnation process. In other words, after the outer peripheral ring 26 is shrink-fit to the segment core assembly 11 as shown in FIGS. 5 and 6, the correction jig 5 is attached to the outer periphery of the outer peripheral ring 26 in the stator 1 as shown in FIGS. 1 and 2. At this time, the correction jig 5 is attached such that the adjustment bolts 52 face the outer periphery of the respective segment cores 25, so as to tighten the adjustment bolts 52. Then, the outer peripheral ring 26 in the stator 1 is restrained from the outer peripheral side, whereby the circularity of the stator 1 is corrected.

Next, as shown in FIG. 11, the stator 1 to which the correction jig 5 is attached is held in the rotary device 61 of the varnish impregnation device 6, and the nozzles 62 are placed above the coil end portions 35 so as to face the coil end portions 35. The inside of the vacuum chamber is heated to a temperature at which the varnish W is hardened during varnish impregnation. The circularity of the stator 1 is corrected using the heating temperature at which the varnish W hardens as a predetermined temperature at which the stator 1 is reheated. This makes it possible to reheat the stator 1 utilizing the heating temperature during varnish impregnation, whereby the time required for the correction process can be reduced and the equipment can be simplified.

It should be noted that heating of the stator 1 in the varnish impregnation process can be performed by using various heating methods, such as induction heating, heating with hot air, and heating by energizing the coil conductor 3.

There is a dimensional error between the slots 23 and the coil conductor 3 due to a variation in dimensional accuracy when the rectangular wire 301 is processed by bending. Therefore, the coil conductor 3 arranged in the respective slots 23 deforms considerably. Due to this deformation, when all the segment cores 25 are assembled to the coil conductor 3, the plurality of segment cores 25 is pressed toward the outer peripheral side by the force that causes the deformed coil conductor 3 to regain its original shape. If the force that presses the segment cores 25 toward the outer peripheral side becomes uneven, the circularity of the stator 1 is reduced.

Meanwhile, in the method of manufacturing the stator 1 according to the present embodiment, in the varnish impregnation process (correction process), the stator 1 is reheated at the predetermined temperature in the state where the circularity of the stator 1 is corrected by the correction jig 5. This reheating reduces the force that causes the coil conductor 3 deformed when arranged in the slots 23 to regain its original shape. Consequently, it is possible to suppress the force that causes the deformed coil conductor 3 to regain its original shape from serving as a residual stress that presses and expands the segment cores 25.

Accordingly, in the method of manufacturing the stator 1 of the present embodiment, it is possible to effectively suppress a reduction in the circularity of the stator 1 after the heated outer peripheral ring 26 is fit to the outer periphery of the plurality of segment cores 25.

Note that, as a method of suppressing a reduction in the circularity of the stator 1, a method may be employed to increase the thickness of the outer peripheral ring 26, or reduce the ratio of the slot 23 of the stator core 2 occupied by the coil conductor 3. However, such method may lower the performance of the rotary electric machine formed with the stator 1, and are therefore not adequate. On the contrary, by correcting the circularity of the stator 1 in the correction process as described above, it is possible to prevent the performance of the rotary electric machine from deteriorating.

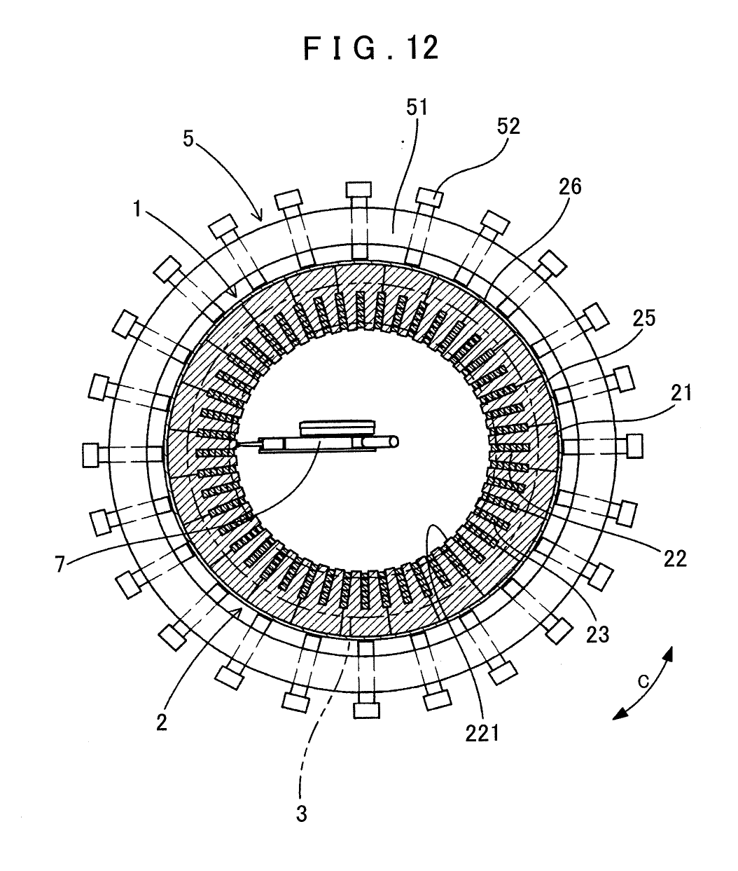

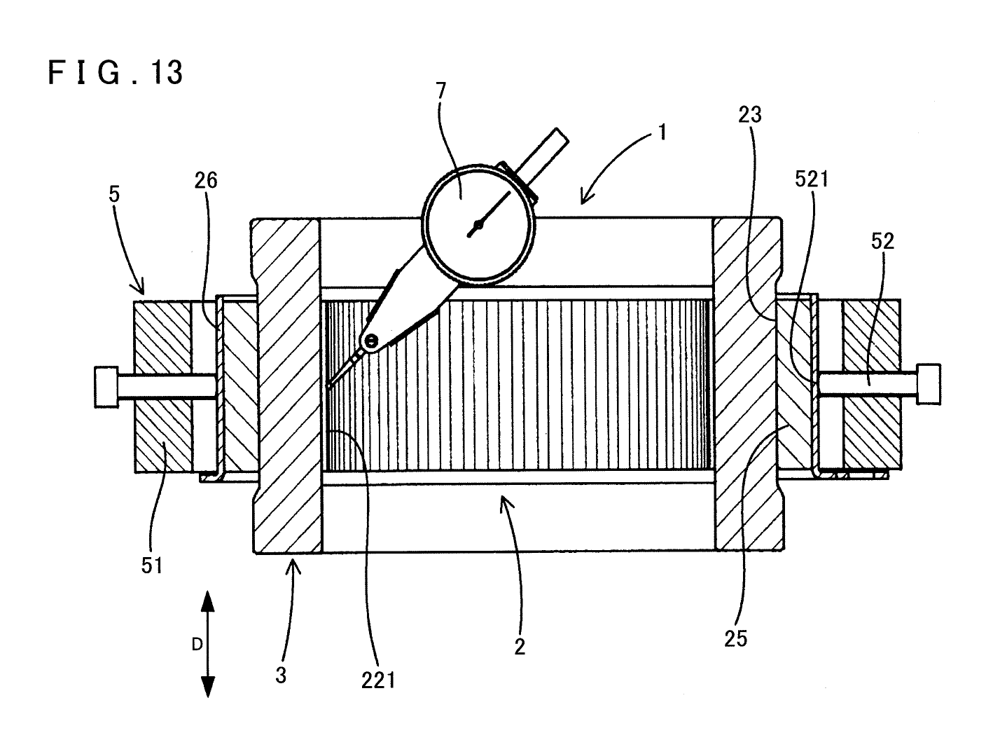

Further, in the correction process described above, as shown in FIGS. 12 and 13, a radius from the center of the stator 1 to inner peripheral surfaces 221 on the teeth portions 22 of the plurality of segment cores 25 may be measured using a measuring device 7 so as to press the segment core 25 with the measured radius larger than that of the other segment cores 25 toward the inner peripheral side by the adjustment bolt 25. Moreover, the radius of the segment cores 25 may also be measured by the measuring device 7 after the adjustment bolts 52 are tightened such that the radius of each of the segment cores 25 as indicated by the measuring device 7 falls within a certain range of error. This makes it possible to make adjustments with feedback while actually measuring the circularity of the stator 1, and thus more reliably improve the circularity of the stator 1.

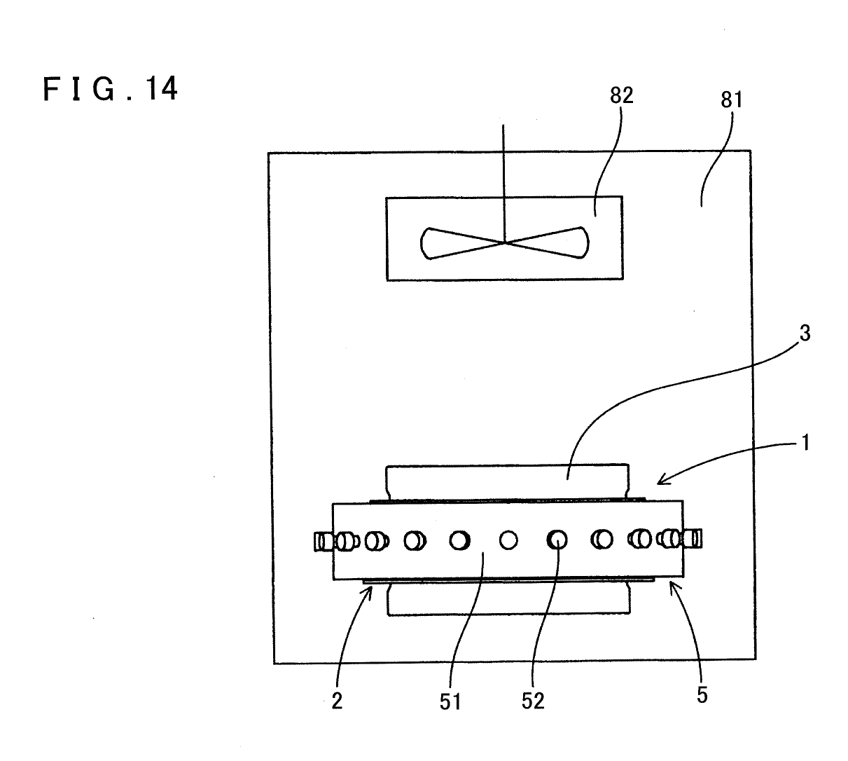

Further, besides the reheating performed in the varnish impregnation process described above, reheating of the stator 1 in the correction process described above may also be performed by heating with hot air the stator 1 corrected using the correction jig 5. This heating with hot air can be performed, as shown in FIG. 14, by arranging the stator 1 in a heating furnace 81 and heating the stator 1 using a hot air fan 82 provided in the heating furnace 81.

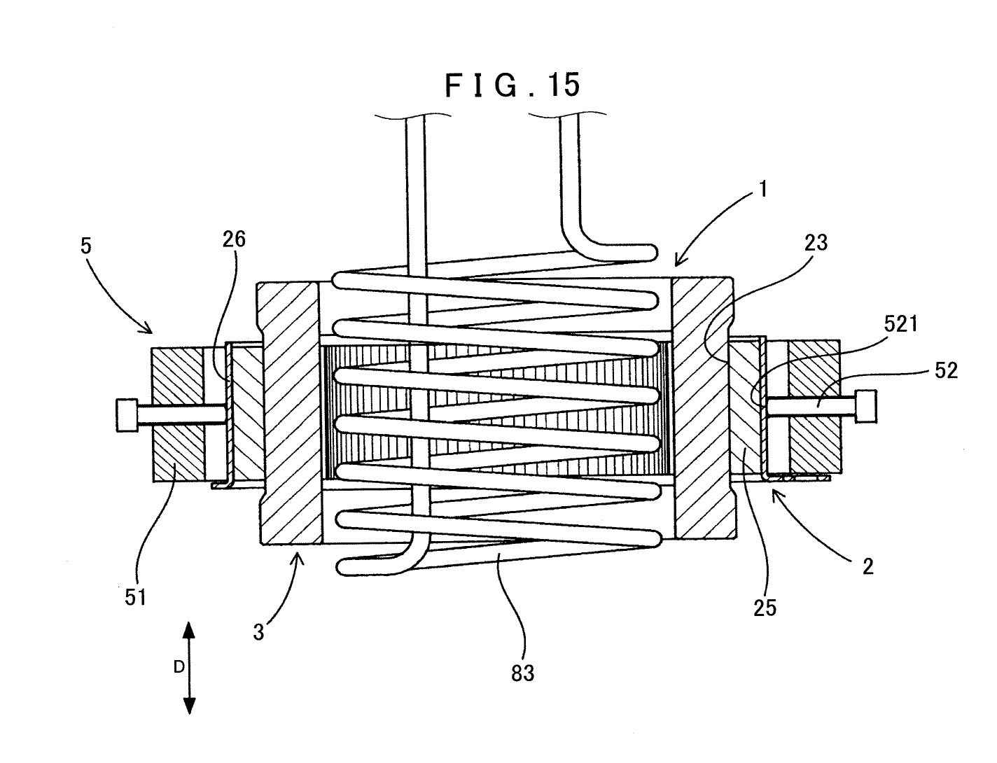

Alternatively, reheating of the stator 1 in the correction process described above may be performed by induction heating of the stator 1 using an induction heating coil 83 arranged on the inner peripheral side of the stator 1, as shown in FIG. 15.

Moreover, although not shown in the drawings, when heating the stator 1 with hot air or by induction heating, the stator 1 may be heated by energizing the coil conductor 3.

### (Confirmation Test)

For this confirmation test, a test was conducted to confirm the effect achieved by performing the above correction process on the stator 1.

More specifically, the radius of the inner peripheral surfaces 221 on the teeth portions 22 in the stator 1 was measured by a measuring device at each of the following stages: before each segment core 25 in the stator 1 was corrected by the correction jig 5 (i.e., before performing the correction process); after each segment core 25 in the stator 1 was corrected by the correction jig 5 (after correction by jig); after each segment core 25 in the stator 1 was corrected by the correction jig 5 and reheated at the predetermined temperature (after heating); and after each segment core 25 in the stator 1 was corrected by the correction jig 5 and reheated at the predetermined temperature, and the correction jig 5 was detached (after jig detachment).

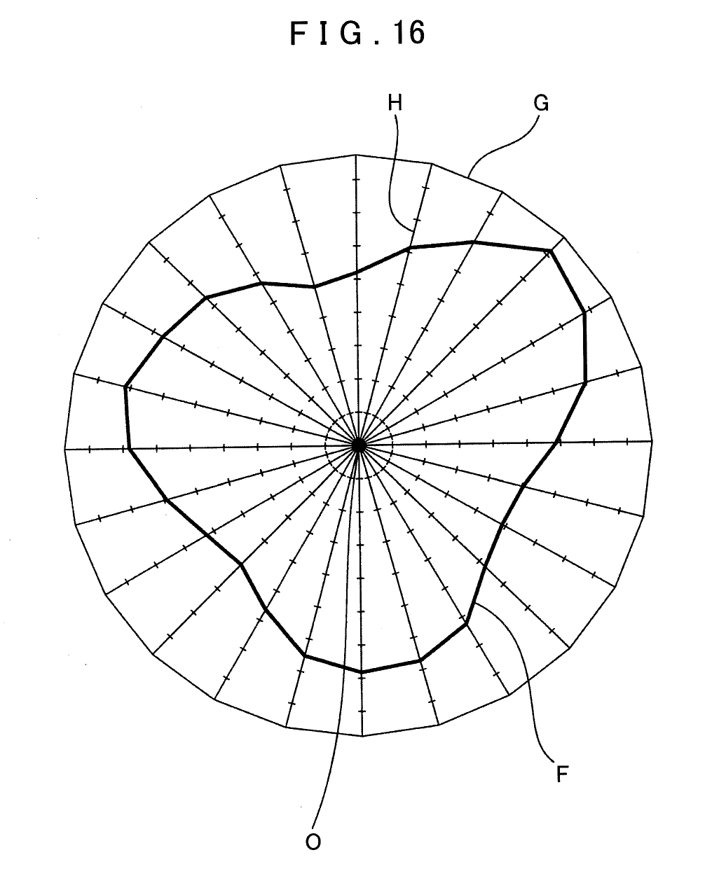

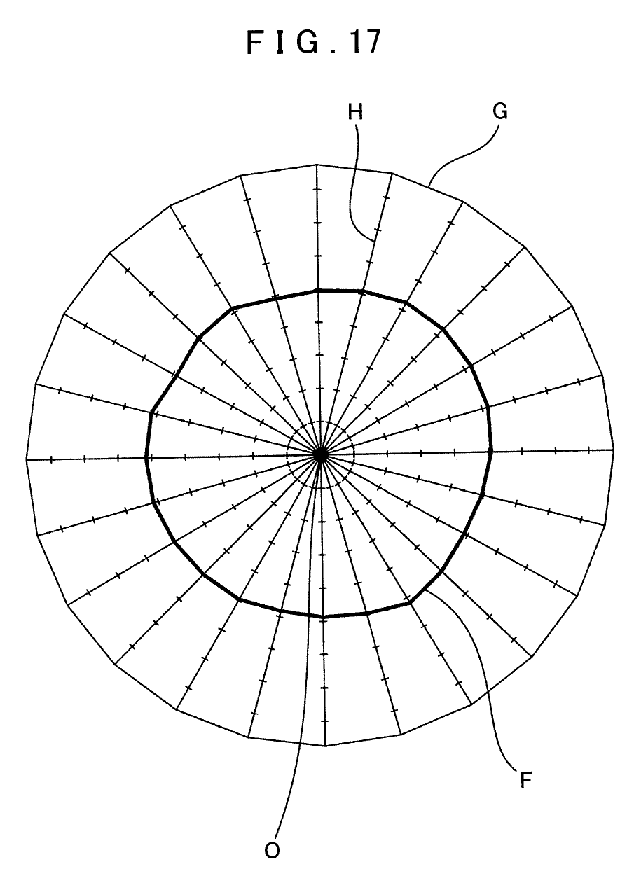

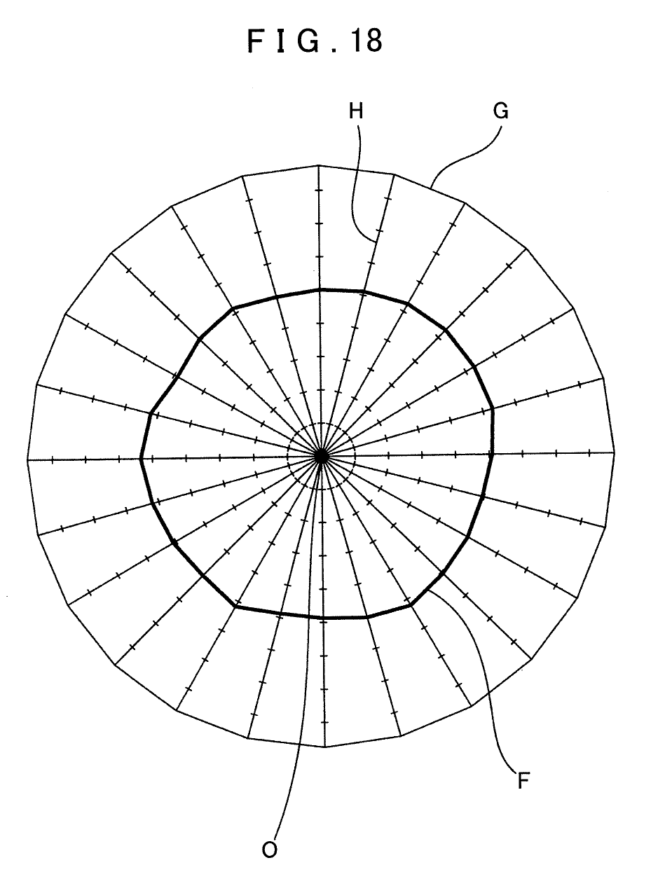

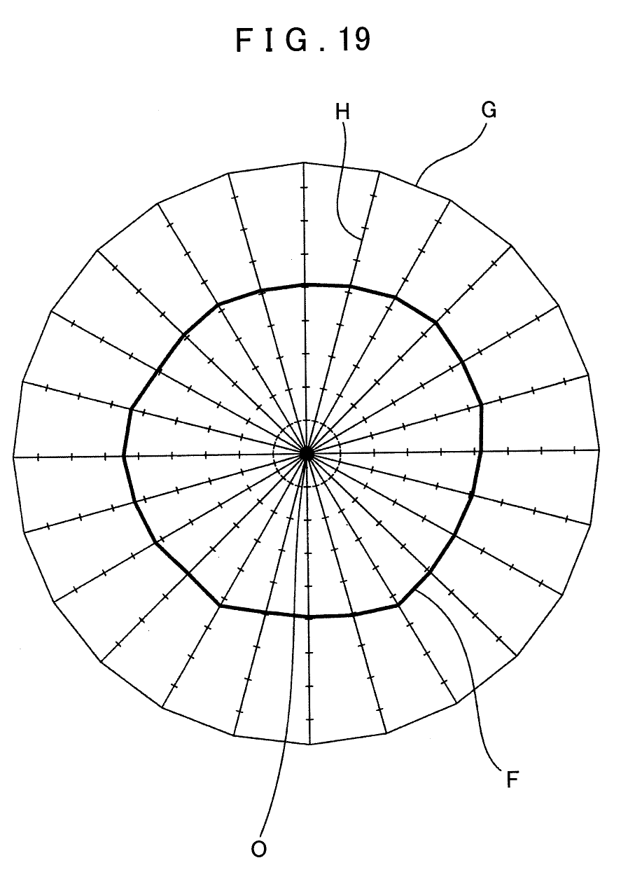

FIG. 16 shows the measurement result before performing the correction process, FIG. 17 shows the measurement result after correction by jig, FIG. 18 shows the measurement result after heating, and FIG. 19 shows the measurement result after jig detachment.

In the drawings, a 66-mm radius of the inner peripheral surfaces 221 on the teeth portions 22 is a center O of the graph circle, and a 67.8-mm radius of the inner peripheral surfaces 221 on the teeth portions 22 is a contour G of the graph circle. Lines H that radially extend indicate the formation positions of the slots 23.

As shown in FIG. 16, there is significant variation in a radius F of the inner peripheral surfaces 221 on the respective teeth portions 22 in the stator 1 before performing the correction process. On the other hand, as shown in FIGS. 17 and 18, after correction by jig and after heating, the variation in the radius F of the inner peripheral surfaces 221 on the teeth portions 22 can be significantly corrected. Moreover, as apparent from FIG. 19, even after detaching the correction jig 5, the correction effect of the radius F of the inner peripheral surfaces 221 on the teeth portions 22 by correction and heating is maintained. As described herein, it has been found that performing the correction process using the above correction jig 5 can effectively suppress a reduction in the circularity of the stator 1 after the heated outer peripheral ring 26 is fit to the outer periphery of the plurality of segment cores 25.

What is claimed is:

1. A method of manufacturing a stator, comprising:
a stator formation process of forming a stator by assembling a plurality of segment cores, which is formed by dividing a stator core in a circumferential direction at a formation position of a slot of the stator core, to a coil conductor that is formed of a rectangular wire bent to include linear portions arranged in the slot and bridge portions that alternately connect the linear portions on one end and the other end of the coil conductor such that the linear portions can be arranged side by side on an imaginary circumference, and fitting a heated outer peripheral ring to an outer periphery of the plurality of segment cores; and
a correction process of reheating the stator at a predetermined temperature in a state where a circularity of the stator is corrected by restraining the outer peripheral ring in the stator so as to improve the circularity of the stator.

2. The method according to claim 1, wherein in the correction process, a correction jig arranged on an outer peripheral side of the outer peripheral ring is used to partially press the outer peripheral ring in the circumferential direction, and
the correction jig includes a body portion arranged on the outer peripheral side of the outer peripheral ring, and an adjustment portion whose radial position is adjusted with respect to the body portion and that presses the corresponding segment core from the outer peripheral side.

3. The method according to claim 2, wherein
the body portion is formed of an annular ring member, and the ring member is formed with screw holes at positions facing an outer peripheral side of the plurality of segment cores,
the adjustment portion is an adjustment bolt that is screwed into each of the screw holes, and
a tip end of the adjustment bolt presses the outer periphery of the corresponding segment core so as to improve the circularity of the stator.

4. The method according to claim 1, wherein
the correction process is performed in a varnish impregnation process of impregnating varnish in a gap between the coil conductor and the slots, and
the predetermined temperature at which the stator is reheated is a heating temperature to harden the varnish.

5. The method of manufacturing a stator according to claim 1, wherein
in the correction process, a radius from a center of the stator to teeth inner peripheral surfaces of each of the plurality of segment cores is measured using a measuring device, and the segment core with the measured radius larger than that of the other segment cores is pressed toward an inner peripheral side so as to improve the circularity of the stator.
A method of manufacturing a stator, comprising:
a stator formation process of forming a stator by assembling a plurality of segment cores, which is formed by dividing a stator core in a circumferential direction at a formation position of a slot of the stator core, to a coil conductor that is formed of a rectangular wire bent to include linear portions arranged in the slot and bridge portions that alternately connect the linear portions on one end and the other end of the coil conductor such that the linear portions can be arranged side by side on an imaginary circumference, and fitting a heated outer peripheral ring to an outer periphery of the plurality of segment cores; and
a correction process of reheating the stator at a predetermined temperature in a state where a circularity of the stator is corrected by restraining the outer peripheral ring in the stator so as to improve the circularity of the stator.
